(19) United States
(12) Patent Application Publication
(10) Pub. No.: US 2024/0144447 A1
(43) Pub. Date: May 2, 2024

(54) SALIENCY MAPS AND CONCEPT FORMATION INTENSITY FOR DIFFUSION MODELS

(71) Applicant: Intel Corporation, Santa Clara, CA (US)

(72) Inventors: Anthony Daniel Rhodes, Portland, OR (US); Ilke Demir, Hermosa Beach, CA (US)

(73) Assignee: Intel Corporation, Santa Clara, CA (US)

(21) Appl. No.: 18/532,273

(22) Filed: Dec. 7, 2023

(51) Int. Cl. G06T 5/70; G06V 10/30; G06V 10/32; G06V 10/46

(52) U.S. Cl. CPC G06T 5/70; G06V 10/30; G06V 10/32; G06V 10/462

(57) ABSTRACT

Deep learning models, such as diffusion models, can synthesize images from noise. Diffusion models implement a complex denoising process involving many denoising operations. It can be a challenge to understand the mechanics of diffusion models. To better understand how and when structure is formed, saliency maps and concept formation intensity can be extracted from the sampling network of a diffusion model. Using the input map and the output map of a given denoising operation in a sampling network, a noise gradient map representative of the predicted noise of a given denoising operation can be determined. The noise gradient maps from the denoising operations at different indices can be combined to generate a saliency map. A concept formation intensity value can be determined from a noise gradient map. Concept formation intensity values from the denoising operations at different indices can be plotted.

### BACKGROUND

Deep learning models (e.g., convolutional neural networks, transformer-based models, etc.) are used in a variety of artificial intelligence and machine learning applications such as computer vision, speech recognition, and natural language processing. Deep learning models may receive and process input such as images, videos, audio, speech, text, etc. Deep learning models can generate outputs, such as features and predictions, based on the input.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG.) 1 illustrates an exemplary training process and an exemplary sampling network of a diffusion model, according to some embodiments of the disclosure.

FIG. 2 illustrates an exemplary trained sampling network and a visualizer of the trained sampling network, according to some embodiments of the disclosure.

FIG. 3 illustrates exemplary operations in a visualizer, according to some embodiments of the disclosure.

FIG. 4 illustrates generated images and corresponding saliency maps, according to some embodiments of the disclosure.

FIG. 5 illustrates a plot of content formation intensity at different denoising operation indices, according to some embodiments of the disclosure.

FIG. 6 is a flowchart showing a method that can help make diffusion models more explainable, according to some embodiments of the disclosure.

FIG. 7 is a block diagram of an exemplary computing device, according to some embodiments of the disclosure.

FIG. 8 is a block diagram of an exemplary deep learning model, such as a U-Net, according to some embodiments of the disclosure.

### DETAILED DESCRIPTION

### Overview

Deep learning models, such as diffusion models, can synthesize images from noise. Diffusion models were inspired by non-equilibrium statistical physics, in which structure is systematically and slowly destroyed by adding noise, and then rebuilt by adding noise back to reconstruct the original structure. The iterative process of adding noise may be referred to as a forward diffusion process. The iterative process of denoising may be referred to as a backward diffusion process.

In the forward diffusion process, noise may be added iteratively to an image. Noise, when added to images, can include random variation of brightness or color information or values of the images. Different types of noise can be added to images. One example of noise is Gaussian noise, which is a statistical noise having a probability function equal to a normal distribution. Other examples of noise may include Gamma noise, Poisson noise, Mixture of Gaussians noise, etc.

During training, training images are fed into the forward diffusion process to generate noisy versions of the training images, and the noisy versions are fed into the backward diffusion process to reconstruct the training images. The backward diffusion process may be referred to as the sampling network. The backward diffusion process can include a complex denoising process involving many denoising operations, e.g., thousands of denoising operations. Parameter(s) in the denoising operations are trained to match the results generated in the backward diffusion process during training. Learned parameter(s) of the backward diffusion process can be used to synthesize images from noise.

It can be a challenge to understand the mechanics of diffusion models. The complexity of diffusion models present obstacles to obtaining a deeper and more intuitive understanding of the denoising operations performed in the backward diffusion process. Lack of understanding of the denoising operations may lead to sub-optimal design of diffusion models and can impair the real-world utility and application of the diffusion models. Designers of diffusion models may make heuristic-driven design choices, which may make many aspects and motivations behind their design choices conceptually nebulous. In addition, information pertaining to how and when structure is formed from noise in the backward diffusion process is not always apparent or known.

To better understand how and when structure is formed, information can be extracted from the sampling network of a diffusion model that is performing the backward diffusion process. The sampling network may include a T number of denoising operations at different indices (e.g., index t may go from T to 1). The sampling network may receive a noisy input (e.g., randomly generated noise input) as input at the first denoising operation at index t=T. The sampling network may output a synthesized image at the last denoising operation at index t=1. For example, the sampling network may include T=1000 denoising operations at indices from 1000 to 1. A denoising operation takes an input map and generates an output map that represents a denoised version of the input map. The output map of a denoising operation at index t may be provided as the input map to a following denoising operation at index t−1. A denoising operation can use one or more learned parameters to generate the output map. A denoising operation may use the one or more learned parameters to predict a denoised version of the input map at the particular index and output the denoised version as the output map. Therefore, pixel-wise differences between the output map and the input map may represent noise values that are predicted by the denoising operation at the particular index. The denoising operation, principally, outputs an output map that is the input map with the predicted noise values removed. A difference between the output map and the input map may represent the predicted noise values of the denoising operation. The noise values may provide insight into how the denoising operation at the particular index is creating structure to generate a denoised version of the input map.

Using the input map and the output map of a given denoising operation in a sampling network and the predicted noise values obtained therefrom, a noise intensity value of the given denoising operation at the given index can be determined. Using the predicted noise values and the noise intensity value, a noise gradient map representative of the predicted noise values at the given denoising operation at the given index can be determined. The noise gradient maps from the denoising operations at different indices can be combined to generate a saliency map. The saliency map may represent cumulative, pixel-level importance or attention given to different pixels of the synthesized image in the denoising operations of the sampling network.

A concept formation intensity value for a particular denoising operation at a particular index can be determined from a noise gradient map of the particular denoising operation. Concept formation intensity values from the denoising operations at different indices can be plotted or analyzed. A plot of the concept formation intensity values across the different indices may quantitatively represent or characterize the temporal evolution of structure formation in the denoising operations over the different indices in the sampling network.

Information, such as saliency maps and concept formation intensity plots, may advantageously make the backward diffusion process explainable and provide insight into how and when structure is formed in the sampling network. The information can help designers better understand the diffusion model and make better, more well informed design choices (e.g., decisions on hyperparameters, decisions on neural network architecture, etc.). The information can be leveraged to improve the performance of diffusion models, including the fidelity of the synthetically generated images. The information can be used to compare how different conditioning inputs may impact the backward diffusion process. The information can be used to provide useful insights for improving methods aimed at detecting and protecting against the malicious use of synthetic data (e.g., deep fakes), adversarial attacks, building trust in deep learning models, etc.

The processes for extracting meaningful information from a diffusion model can be applied to a variety of diffusion models, such as conditioned diffusion models, unconditioned diffusion models, image-to-image synthesis diffusion models, text-to-image synthesis diffusion models, etc. The processes are also applicable regardless of the type of deep learning model used in individual denoising operations of the sampling network.

### How Diffusion Models Work and How Diffusion Models are Trained

FIG. 1 illustrates an exemplary training process 160 and an exemplary sampling network 106 of a diffusion model, according to some embodiments of the disclosure. The sampling network 106 of a diffusion model is tasked with generating synthetic images that resemble the underlying training data distribution from which the model was trained. Training process 160 may include a forward diffusion process 102 and a backward diffusion process 104.

In the forward diffusion process 102, an uncorrupted input image, x₀, is ingested, and is slowly corrupted over a T number of corrupting operations at indices t going from 1 to T. A corrupting operation at index t takes the output of the corrupting operation at index t−1 as input and adds, e.g., Gaussian noise, to the input. x₀˜q(x₀) may represent an initial (uncorrupted) image, and xₜ may represent a corrupted image following t corrupting operations of the forward diffusion process 102. x_{T} may represent a corrupted image following T corrupting operations. The forward diffusion process 102 can form a Markov Process that may gradually add Gaussian noise according to a variance schedule corresponding to the different indices. The corrupting operations of the forward diffusion process 102 may receive an uncorrupted input and produce progressively more noisy images at each index.

In the backward diffusion process 104, a corrupted image x_{T} following T corrupting operations of the forward diffusion process 102 is ingested and is slowly reconstructed back into the uncorrupted input image x₀ over a T number of denoising operations at indices t going from T to 1. The denoising operations of the backward diffusion process 104 may reverse the corresponding corrupting operations in the forward diffusion process 102. The denoising operations of the backward diffusion process 104 may receive a noisy input and produce progressively less noisy images at each index.

Sampling network 106 can be trained to perform or emulate the backward diffusion process 104. Sampling network 106 may be designed to perform denoising operations. The overall structure of sampling network 106 composed of denoising operations may mirror the denoising operations in backward diffusion process 104. In some embodiments, sampling network 106 is constructed using a series or network of denoising operations at different indices, e.g., indices t going from T to 1:
Denoising operation 110_{T} at index t=T, may be a first denoising operation in sampling network 106.
A denoising operation at index t=T−1 (not depicted explicitly in FIG. 1), may be a second denoising operation in sampling network 106.
Denoising operation 110ₜ₊₁ at index t+1, may be a (T−t)^{th} denoising operation in sampling network 106.
Denoising operation 110ₜ at index t, may be a (T−t+1)^{th} denoising operation in sampling network 106.
Denoising operation 110ₜ₋₁ at index t−1, may be a (T−t+2)^{th} denoising operation in sampling network 106.
A denoising operation at index t=2 (not depicted explicitly in FIG. 1), may be a second to the last denoising operation in sampling network 106.
Denoising operation 110₁ at index t=1, may be a last denoising operation in sampling network 106.

As illustrated, sampling network 106 may include T denoising operations 110, e.g., denoising operation 110_{T}, . . . denoising operation 110ₜ₊₁, denoising operation 110ₜ, denoising operation 110ₜ₊₁, and denoising operation 110₁. The denoising operations 110 may be implemented in a series such that an output map generated by a denoising operation 110ₜ at index t is provided as an input map to a following denoising operation 110ₜ₋₁ at index t−1:
Denoising operation 110_{T} at index t=T, e.g., a first denoising operation in sampling network 106, may receive a noisy input, x_{T}, as an input map, and generate an output map, x_{T-1}, representing a denoised version of the input map.
A denoising operation at index t=T−1 (not depicted explicitly in FIG. 1), e.g., a second denoising operation in sampling network 106, may receive x_{T-1} as an input map and generate an output map, x_{T-2}, representing a denoised version of the input map.
Denoising operation 110ₜ₊₁ at index t+1, e.g., a (T−t)^{th} denoising operation in sampling network 106, may receive xₜ₊₁ as an input map and generate an output map, xₜ, representing a denoised version of the input map.
Denoising operation 110ₜ at index t, e.g., a (T−t+1)^{th} denoising operation in sampling network 106, may receive xₜ as an input map and generate an output map, xₜ₋₁, representing a denoised version of the input map.
Denoising operation 110ₜ₋₁ at index t−1, e.g., a (T−t+2)^{th} denoising operation in sampling network 106, may receive xₜ₋₁ as an input map and generate an output map, xₜ₋₂, representing a denoised version of the input map.
A denoising operation at index t=2 (not depicted explicitly in FIG. 1), e.g., a second to the last denoising operation in sampling network 106, may receive x₂ as an input map and generate an output map, x₁, representing a denoised version of the input map.
Denoising operation 110₁ at index t=1, e.g., a last denoising operation in sampling network 106, may receive x₁ as an input map and generate an output map, x₀, representing a denoised version of the input map. When sampling network 106 is synthesizing a generated image from a noisy input, the output map is denoted as [symbol] .

In the context of diffusion models, an input map and an output map may refer to an input image and an output image respectively. An input map may have pixels that form the input image. An input map may include a 1-dimensional vector. An input map may include a 2-dimensional matrix having rows and columns. In some cases, the input map may have higher dimensionality (e.g., the input map may include a 3-dimensional tensor). An output map may have pixels that form the output image respectively. An output map may include a 1-dimensional vector. An output map may include a 2-dimensional matrix having rows and columns. In some cases, the output map may have higher dimensionality (e.g., the output map may include a 3-dimensional tensor).

A denoising operation 110 in sampling network 106 may be implemented using a deep learning model. The deep learning model may have one or more parameters that can be trained to generate the images produced by the corresponding denoising operation in backward diffusion process 104.

An example of a deep learning model implementing a denoising operation 110 in sampling network 106 may include an autoencoder. Autoencoders are a type of artificial neural network that can be trained to copy input map to the output map as much as possible. An autoencoder may include two parts: an encoder and a decoder. The encoder can transform the input map into a lower dimensional latent representation, and the decoder can reconstruct the original input map from the latent representation and produce an output map. Examples of autoencoders may include, e.g., sparse autoencoders, denoising autoencoders, contractive autoencoders, and variational autoencoders. Each variant could have a different way of regularizing or constraining the latent representation, to make it more useful or meaningful. An autoencoder may be implemented to perform a denoising operation in sampling network 106 to randomly generate new data that is similar to the input data.

Another example of a deep learning model implementing a denoising operation 110 in sampling network 106 may be a U-Net. A U-Net may be a type of convolutional neural network. A U-Net may have a U-shaped architecture that comprises a contracting path and an expansive path. The contracting path can capture the context of the input map, while the expansive path can reconstruct the output map with precise localization.

During training process 160, a collection of uncorrupted input images can be deconstructed and reconstructed using the forward diffusion process 102 and the backward diffusion process 104 respectively. The images and the output maps produced in the backward diffusion process 104 can then used as training data to determine the one or more parameters of the sampling network 106, denoted as θ. The one or more parameters of the sampling network 106 may include one or more parameters of the denoising operations 110 in the sampling network 106 (e.g., kernel weights used in the deep learning model of the denoising operations 110). The training data can be used to train the parameter(s) of the sampling network 106 to predict the denoising process, or an aspect of the denoising process of the backward diffusion process 104. A loss function can be defined to capture how well the denoising operations 110 in the sampling network 106 predicted the noise being removed in the denoising operations of the backward diffusion process 104. The parameter(s) of the sampling network 106 can be determined or optimized to minimize the loss function, e.g., using gradient descent. The parameter(s) of the sampling network 106 can be determined or optimized to match the training data, e.g., images produced in the backward diffusion process 104. The parameter(s) of the sampling network 106 can be determined or optimized to emulate the behavior of the denoising operations in the backward diffusion process 104. The parameter(s) of the sampling network 106 can be determined or optimized to predict the noise added in a corresponding index in the forward diffusion process 102, and/or the noise being removed in the corresponding index in the backward diffusion process 104.

In some embodiments, conditioning 170 may be provided to sampling network 106 as an additional input to sampling network 106. Conditioning 170 can guide the generative process in sampling network 106 to produce samples that match some desired criteria prescribed or embedded in conditioning 170. For example, one might want to generate images of cats with different breeds doing different activities in different styles. The criteria may be converted into a vector of floating point numbers. The vector as part of conditioning 170 may then be fed into denoising operations 110. The conditioning criteria can be converted into a vector in a variety of ways. One possible way is to use an embedding layer (not depicted explicitly in FIG. 1) that maps discrete labels (such as cat breeds) to vectors. Another way is to use a text encoder that converts natural language descriptions (such as “an adventure tuxedo cat going snowboarding”) to vectors. Another way is to use a feature extractor that extracts relevant features from another image (such as the style or the background) and use the features as vectors. The vector in conditioning 170 can be used to modify the noise distribution predicted at each denoising operation at an index of sampling network 106. The vector can be either be added to the predicted noise or by multiplying it with the predicted noise. The predicted noise at each denoising operation at an index of sampling network 106 may become dependent on the conditioning. The sampling network 106 may learn to denoise the noisy image in a way that satisfies the conditioning 170.

After training process 160, sampling network 106 may be provisioned with one or more learned parameters for the denoising operations 110 of sampling network 106. Using the one or more learned parameters, sampling network 106 may receive a noisy input, x_{T}, e.g., a noisy input image generated with random noise and generate and/or output a generated image [symbol] , e.g., a synthesized image. A first denoising operation 110_{T} may receive the noisy input, and a last denoising operation 110₁ may output the generated image.

### Making Diffusion Models Explainable

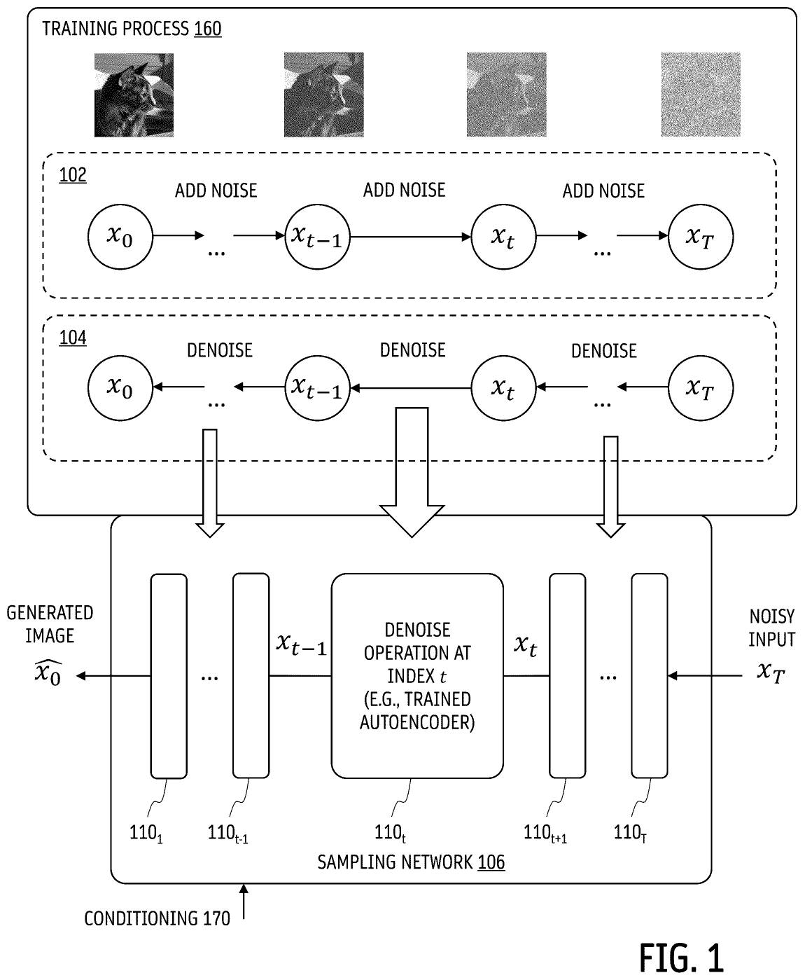

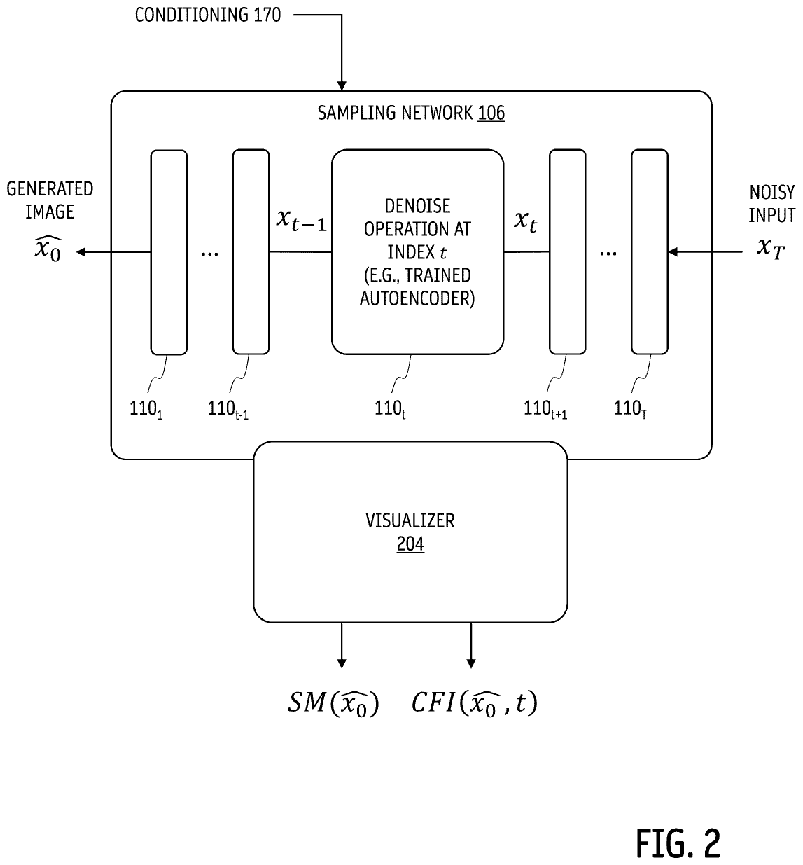

FIG. 2 illustrates an exemplary (trained) sampling network 106 and a visualizer 204 of the trained sampling network, according to some embodiments of the disclosure. The denoising process of sampling network 106 may begin with sampling a random Gaussian vector from a multi-variate Gaussian to obtain a noisy input x_{T}. The learned parameter(s) of denoising operations 110 are used to predict the noise that was added in a corresponding index of the forward diffusion process or removed in a corresponding index of the backward diffusion process. By observing and analyzing the input maps and output maps of the denoising operations 110, visualizer 204 may extract information about the denoising process of sampling network 106, e.g., from the noise values predicted by the denoising operations 110 at different indices. The extracted information may include information about individual denoising operations at different indices. The information about individual denoising operations at different indices may include one or more of:
information about the predicted noise values at a given denoising operation at a given index,
information about the predicted noise intensity at a given denoising operation at a given index,
spatial/regional information about structure formation, such as a noise gradient map, at a given denoising operation at a given index, and
information about the overall structure formation intensity of a given denoising operation at a given index.

Equipped with the information about individual denoising operations at different indices, visualizer 204 may characterize the evolution of the information across different indices (at different times or different denoising operations of the sampling network 106, thus steps of the denoising process performed by sampling network 106).

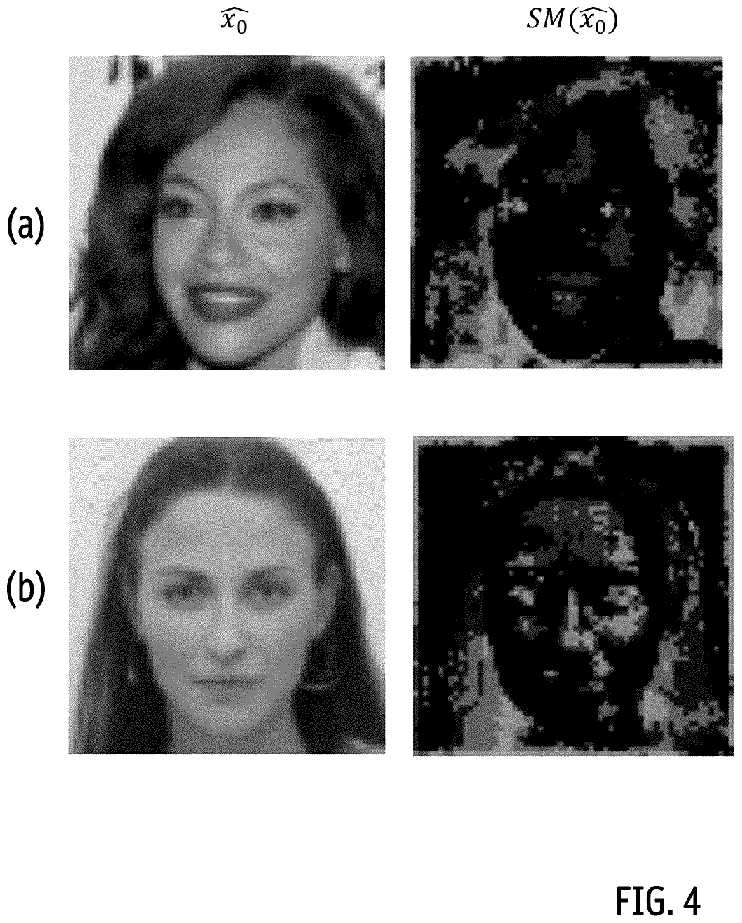

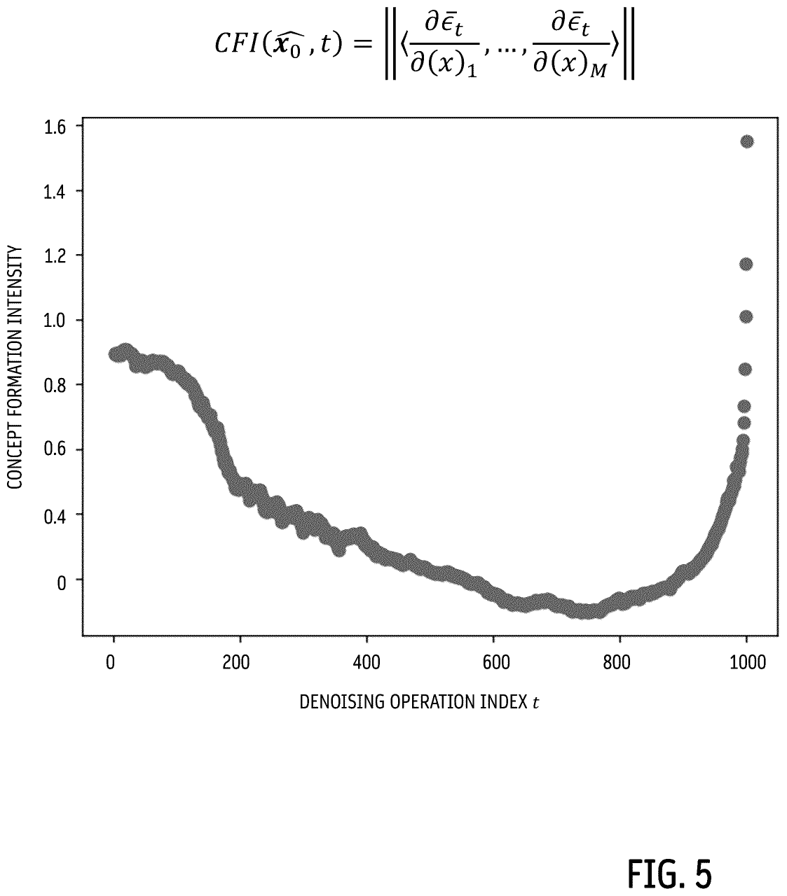

Visualizer 204 may have access to the input maps and output maps of denoising operations 110 in sampling network 106 and can use the input maps and output maps to derive such information. Details about how such information can be extracted by visualizer 204 are described with figures (FIGS.) 3 and 6. Visualizer 204 may produce one or more graphical visualizations based on the information, and the graphical visualizations may be output to a user for understanding and further analysis. Examples of the graphical visualizations are depicted in FIGS. 4-5.

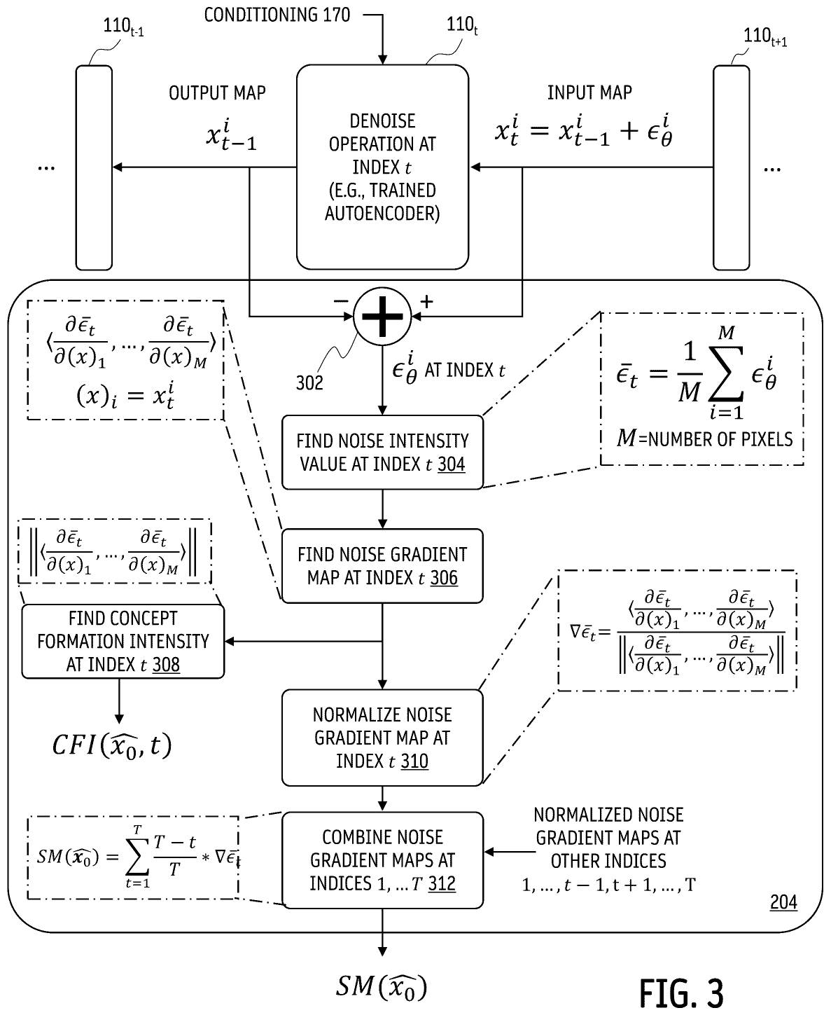

FIG. 3 illustrates exemplary operations in visualizer 204, according to some embodiments of the disclosure. The operations in visualizer 204 may extract information about the denoising operations in a sampling network, and produce information about the overall denoising process performed by the sampling network. The depicted operations 302, 304, 306, 308, and 310 in visualizer 204 are described with respect to extracting information for a denoising operation 110ₜ at index t. It is envisioned that the depicted operations 302, 304, 306, 308, and 310 can be performed for one or more other denoising operations at other indices, e.g., 1, . . . , t−1, t+1, . . . , T.

For a denoising operation 110ₜ at index t, an input map xₜⁱ may be provided as an input map to the denoising operation 110ₜ. Denoising operation 110ₜ may receive the input map xₜⁱ. Denoising operation 110ₜ may predict the noise ϵ_{θ}ⁱ that was added in a corresponding index in the forward diffusion process 102, and/or the noise ϵ_{θ}ⁱ being removed in the corresponding index in the backward diffusion process 104. The predicted noise may be denoted as ϵ_{θ}ⁱ, or ϵ_{θ}ⁱ(xₜ,t), where ϵ_{θ}ⁱ may denote predicted noise using the one or more parameters θ of the denoising operation 110ₜ at index t. The input map xₜⁱ may have the noise ϵ_{θ}ⁱ that is pixel-wise added to the denoised version of the input map xₜ₋₁ⁱ:

xₜⁱ=xₜ₋₁ⁱ+ϵ_{θ}ⁱ (eq. 1)

Denoising operation 110ₜ may generate an output map xₜ₋₁ using one or more learned parameters of the denoising operation 110ₜ at index t. The output map xₜ₋₁ may represent a denoised version of the input map:

xₜ₋₁ⁱ=xₜⁱ−ϵ_{θ}ⁱ (eq. 2)

i may denote a pixel index, having a range of values from 1 to M, where M=a total number of pixels of the input map=a total number of pixels of the output map.

Visualizer 204 may include a pixel-wise (adding or subtracting) operation 302 to obtain predicted noise values ϵ_{θ}ⁱ. Pixel-wise operation 302 may determine pixel-wise differences between the input map and the output map to determine the predicted noise values ϵ_{θ}ⁱ corresponding to pixels of the input map. The predicted noise values ϵ_{θ}ⁱ may correspond to the noise values of denoising operation 110ₜ at index t.

Visualizer 204 may include operation 304 to find noise intensity value ϵ̅ₜ at index t. Operation 304 may determine a noise intensity value ϵ̅ₜ at index t using the noise values ϵ_{θ}ⁱ obtained by pixel-wise adder or subtractor 302. A noise intensity value ϵ̅ₜ at index t may represent a characteristic noise intensity value (e.g., a value characteristic of the predicted noise values) of denoising operation 110ₜ at index t. A noise intensity value ϵ̅ₜ at index t may represent an average or mean of noise values predicted by denoising operation 110ₜ at index t, where ϵ̅ₜ comprising a mean of the noise values may be determined by operation 304 according to the following:

$$\\ \begin{matrix}{\overline{ϵ}}_{{}^{} t} = \frac{1}{M} {\sum }_{i = 1}^{M} {ϵ}_{{}^{} θ}^{{}^{} i} & ( eq . 3 )\end{matrix}$$

In some cases, a noise intensity value ϵ̅ₜ at index t may represent a mode of noise values ϵ_{θ}ⁱ predicted by denoising operation 110ₜ at index t. Operation 304 may determine a mode of the noise values ϵ_{θ}ⁱ. In some cases, a noise intensity value ϵ̅ₜ at index t may represent a median of noise values predicted by denoising operation 110ₜ at index t. Operation 304 may determine a median of the noise values ϵ_{θ}ⁱ. In some cases, a noise intensity value ϵ̅ₜ at index t may represent a maximum of noise values predicted by denoising operation 110ₜ at index t. Operation 304 may determine a maximum of the noise values ϵ_{θ}ⁱ. In some cases, a noise intensity value ϵ̅ₜ at index t may represent a minimum of noise values predicted by denoising operation 110ₜ at index t. Operation 304 may determine a minimum of the noise values ϵ_{θ}ⁱ. Operation 304 may determine a suitable combination of statistics of the noise values that and used a combined statistic as the noise intensity value ϵ̅ₜ at index t. The combined statistic may characterize noise intensity of the denoising operation 110ₜ at index t.

Visualizer 204 may include operation 306 to find a noise gradient map of the denoising operation 110ₜ at index t. Operation 306 may determine a noise gradient map using the noise intensity value ϵ̅ₜ determined in operation 304. Operation 306 may determine a gradient of the noise intensity value ϵ̅ₜ with respect to each pixel of the input map, denoted by (x)ᵢ=xₜⁱ. The gradient may be determined by operation 306 by determining pixel-wise partial derivatives characterizing of a change in the noise intensity value ϵ̅ₜ with respect to a change in the pixel (x)ᵢ produced by the denoising operation 110ₜ at index t. The noise gradient map may be represented mathematically as follows, as a vector of values corresponding to each pixel:

$$\\ \begin{matrix}〈 \frac{\partial {\overline{ϵ}}_{{}^{} t}}{\partial {( x )}_{1}} , … , \frac{\partial {\overline{ϵ}}_{{}^{} t}}{\partial {( x )}_{M}} 〉 & ( eq . 4 )\end{matrix}$$

The noise gradient map may include pixel-wise partial derivatives of the noise intensity value ϵ̅ₜ with respect to a pixel (x)ᵢ of the input map.

$$\\ \frac{\partial {\overline{ϵ}}_{{}^{} t}}{\partial {( x )}_{1}}$$

may represent the rate of change of the noise intensity value ϵ̅ₜ at index t with respect to a change in the pixel (x)ᵢ of the input map of the denoising operation 110ₜ at index t.

Using automatic differentiation techniques implemented with neural networks of the denoising operations in the sampling network, it is possible to obtain the noise gradient map for the denoising operation 110ₜ at index t, which includes pixel-wise partial derivatives tracking a change in the noise intensity value ϵ̅ₜ with respect to a change in a pixel (x)ᵢ. Automatic differentiation techniques, with knowledge of the operations performed in the neural network of denoising operation 110ₜ at index t, e.g., additions, matrix multiplications, sigmoid functions, activation functions, convolutions, etc., the derivatives of the operations can be determined. In the sampling network, the changes in the pixel (x)ᵢ of the input/output map of the denoising operation 110ₜ at index t can be well tracked by the automatic differentiation techniques as a pixel undergoes changes and transformations in the denoising operation 110ₜ at index t. The changes are tracked as part of the neural network software libraries implementing automatic differentiation techniques. Because the noise intensity value ϵ̅ₜ can be computed for the denoising operation 110ₜ at index t, and the changes in the noise intensity value ϵ̅ₜ can also be tracked as well for the denoising operation 110ₜ at index t. As a result, the noise gradient map can be determined, which includes pixel-wise partial derivatives of the noise intensity value ϵ̅ₜ with respect to a pixel (x)ᵢ.

The noise gradient map may measure pixel-wise importance, saliency, and/or attention at the denoising operation 110ₜ at index t, because the gradient can quantify pixel-wise, intensity of predicted noise values ϵ_{θ}ⁱ (e.g., how much structure is being created for different pixels) with respect to an overall noise intensity value ϵ̅ₜ characteristic of the denoising operation 110ₜ at index t.

Visualizer 204 may (optionally) include operation 310 to normalize the noise gradient map to obtain a normalized noise gradient map. Operation 310 may desensitize the gradient from being impacted by changes in the overall noise intensity value at different the denoising operations 110 at different indices. Operation 310 may normalize the pixel-wise partial derivatives in operation 306 based on a magnitude of the noise gradient map, e.g., including the pixel-wise partial derivatives of the denoising operation 110ₜ at index t, denoted as

$$\\ ‖ 〈 \frac{\partial {\overline{ϵ}}_{{}^{} t}}{\partial {( x )}_{1}} , … , \frac{\partial {\overline{ϵ}}_{{}^{} t}}{\partial {( x )}_{M}} 〉 ‖ .$$

Operation 310 may perform a normalization operation as follows to obtain a normalized noise gradient map, denoted as ∇ϵ̅:

$$\\ \begin{matrix}∇ {\overline{ϵ}}_{{}^{} t} = \frac{〈 \frac{\partial {\overline{ϵ}}_{{}^{} t}}{\partial {( x )}_{1}} , … , \frac{\partial {\overline{ϵ}}_{{}^{} t}}{\partial {( x )}_{M}} 〉}{‖ 〈 \frac{\partial {\overline{ϵ}}_{{}^{} t}}{\partial {( x )}_{1}} , … , \frac{\partial {\overline{ϵ}}_{{}^{} t}}{\partial {( x )}_{M}} 〉 ‖} & ( eq . 5 )\end{matrix}$$

In operation 310, the pixel-wise partial derivatives may be individually divided by the magnitude of the pixel-wise partial derivatives, e.g., the magnitude of the noise gradient map.

The gradient maps from operation 306 and/or operation 310 may offer signals that are indicative of spatial/regional saliency, importance, and/or attention given to certain pixels during different denoising operations at different indices of the denoising process. Visualizer 204 may (optionally) include operation 312 to combine the noise gradient maps generated by operation 306 for the different denoising operations at the different indices or normalized gradient maps generated by operation 310 for the different denoising operations at the different indices. Operation 312 may receive (normalized) noise gradient maps corresponding to the different denoising operations at the different indices, where index t=1, 2, . . . T. Operation 312 may pixel-wise accumulate or sum up the (normalized) noise gradient maps to determine a saliency map, denoted by SM( [symbol] ). Operation 312 may accumulate or sum up the values in the (normalized) noise gradient map corresponding to a particular pixel over the different indices. A summation or accumulation of values in the (normalized) noise gradient map can be performed for each pixel to produce a saliency map having values for each pixel. A saliency map can summarize and cumulate pixel-wise saliency, attention and/or importance, for the whole denoising process, and convey which pixels or areas of a generated image received more attention than other pixels or areas in the denoising process. Values in the saliency map corresponding to different pixels can convey how much attention different pixels received or how much importance different pixels had in the denoising process. In some cases, operation 312 may determine a saliency map as follows:

SM( [symbol] )=Σₜ₌₁^{T}∇ϵ̅ₜ (eq. 6)

The backward diffusion process may be a structured process starting with a denoising process at the first index t=T, and culminating in a high-fidelity synthetic image at the final index t=1. Operation 312 may accumulate the noise gradient maps ∇ϵ̅ₜ using weights corresponding to the different denoising operations at the different indices. The weights may become higher or bigger when the noise gradient map ∇ϵ̅ₜ of the denoising operation at index t is closer to final denoising operation at index t=1. The weights may become higher as more denoising operations have been performed, where the contribution of a noise gradient map is higher as the index is closer to the final denoising operation. The intuition behind the weights may be based on the inductive thesis that structure is gradually becoming more cohesive in the denoising process. In some cases, operation 312 may determine a saliency map using weights as follows:

$$\\ \begin{matrix}SM ( ) = {\sum }_{t = 1}^{T} \frac{T - t}{T} * ∇ {\overline{ϵ}}_{{}^{} t} & ( eq . 7 )\end{matrix}$$

A depth of the denoising operation at index t may be considered T−t, indicating how many denoising operations have been performed.

$$\\ \frac{T - t}{T}$$

may correspond to the weights that are used in a weighted accumulation of the noise gradient maps ∇ϵ̅ₜ.

$$\\ \frac{T - t}{T}$$

may become higher or bigger as index t goes from t=T to t=1, or as the depth of the denoising operation becomes higher. A weight may scale up as the noise gradient maps ∇ϵ̅ₜ correspond to denoising operations that are deeper in the denoising process of the sampling network. A weight may include a depth of a particular denoising operation at a particular index (e.g., T−t) in the sampling network divided by a total number of denoising operations in the sampling network (e.g., T). If the indices are flipped to go from t=1 to t=T, the weights may correspond to t/T.

In some cases, operation 312 may combine a subset of (normalized) noise gradient maps (e.g., a subset of (normalized) noise gradient maps corresponding to denoising operations having noise intensity values above a threshold, or belonging to a certain percentile). In some cases, operation 312 may combine a subset of (normalized) noise gradient maps (e.g., a subset of (normalized) noise gradient maps corresponding to denoising operations having an index within a particular window or range). In some cases, operation 312 may combine a subset of (normalized) noise gradient maps (e.g., a subset of (normalized) noise gradient maps corresponding to later denoising operations deeper in the denoising process). In some cases, operation 312 may combine a subset of values in the (normalized) noise gradient map corresponding to a particular pixel over the different indices (e.g., a subset of values in the (normalized) noise gradient map being above a threshold, or belonging to a certain percentile).

Visualizer 204 may generate a graphical visualization of saliency map produced in operation 312 and output the graphical visualization for display to a user. Values in the saliency map can be rendered as pixels of the graphical visualization. Examples of saliency maps are illustrated in FIG. 4.

Visualizer 204 may (optionally) include operation 308 to find concept formation intensity at index t, denoted as CFI( [symbol] ,t). Different denoising operations at different indices may have different concept formation intensity values. Operation 308, in the denoising operation 110ₜ at index t, can determine a concept formation intensity value based on a magnitude of the noise gradient map. The concept formation intensity value may summarize the intensity of the noise gradient map of a particular denoising operation at a particular index. The concept formation intensity value may be determined based on pixel-wise partial derivatives of the noise intensity value with respect to the noise values (e.g., values in the (unnormalized) noise gradient map

$$\\ 〈 \frac{\partial {\overline{ϵ}}_{{}^{} t}}{\partial {( x )}_{1}} , … , \frac{\partial {\overline{ϵ}}_{{}^{} t}}{\partial {( x )}_{M}} 〉$$

as determined in operation 306). The concept formation intensity value may be determined based on a magnitude of the noise gradient map determined in operation 306. Operation 308 may perform the following to obtain the concept formation intensity value for a denoising operation 110ₜ at index t:

$$\\ \begin{matrix}CFI ( , t ) = ‖ 〈 \frac{\partial {\overline{ϵ}}_{{}^{} t}}{\partial {( x )}_{1}} , … , \frac{\partial {\overline{ϵ}}_{{}^{} t}}{\partial {( x )}_{M}} 〉 ‖ & ( eq . 8 )\end{matrix}$$

Concept formation intensity values corresponding to various denoising operations 110 at different indices can give insight as to when structure is formed in the denoising process of the sampling network, and how intense the structure is being formed at a particular denoising operation at a particular index.

Visualizer 204 may generate a graphical visualization of a plot having concept formation intensity values plotted for the different indices produced in operation 318, and output the graphical visualization for display to a user. Concept formation intensity values can be rendered as points of a plot. An example of a plot is illustrated in FIG. 5.

### Examples of Saliency Maps

FIG. 4 illustrates generated images and corresponding saliency maps, according to some embodiments of the disclosure. Part (a) of FIG. 4 includes a generated image [symbol] and a corresponding saliency map SM( [symbol] ) generated using the processes describe herein. Part (b) of FIG. 4 includes a different generated image [symbol] and a different corresponding saliency map SM( [symbol] ) generated using the processes describe herein. Lighter shading for a pixel in the saliency map indicates a higher value in the salient map.

Some observations can be made from the saliency maps illustrated in FIG. 4. On faces, the diffusion process appears to concentrate focus on a few complex features consistently, such as: eyes (a common feature used for deepfake detection), hair, contours that form the periphery of the face, light shading consistency, and the extreme periphery of the image (where visual inconsistencies are often easier to spot). By contrast, less attention appears to be focused on the more generic details of the image, including the background (unless an outlier object/contour is present), lips, and the neck. The observations can help designers better understand the diffusion model and explain the complex diffusion process.

Understanding which areas a diffusion model may pay most attention to when generating images can help inform how to better classify whether an image is a deep fake or not. Areas of the image can be cropped or highlighted and fed to a classifier. The classifier can focus on those areas and potentially improve the ability of the classifier to distinguish between a synthetic image or a non-synthetic image. Pairs of generated images and saliency maps can be used as training data to train a diffusion saliency area identification model. The diffusion saliency area identification model can be used to ingest an image and predict areas of the image that a deep fake classifier should focus on when distinguishing between a synthetic image or a non-synthetic image.

It is possible to visually compare saliency maps for generated images conditioned on different conditionings, as well, to better assess and reveal the impact of different conditionings on the generated images and the diffusion processes that produced the generated images. A first noisy input and a first conditioning may be provided as input to the sampling network to produce a first synthetic image and a first saliency map. The same noisy input and a second conditioning (different from the first conditioning) may be provided as input to the sampling network to produce a second synthetic image and a second saliency map. The first saliency map and the second saliency map can be compared to better understand the impact or effects of the different conditionings.

### Example of a Concept Formation Intensity Plot

FIG. 5 illustrates a plot of content formation intensity at different denoising operation indices, according to some embodiments of the disclosure. The horizontal axis of the plot represents a number of denoising operations, or depth of the denoising operation at index t within the sampling network. The vertical axis of the plot represents content formation intensity. A plot of a single run of the sampling network is depicted in FIG. 5. Insights about the generative structure-forming process may be revealed by the plot. The denoising, structure-forming, generation process can encompass a few recognizable stages:
Structure can be defined and determined very early (from the model's perspective, even though this might not be directly discernible to human observers). Structure may be defined in, e.g., the first ^{˜}20% of the generation process, even despite the presence of noise dominance.
The first portion of the generation process may be followed by a lengthy phase of less clear structure in, e.g., the middle ^{˜}70% of the generation process.
Finally, there is a refinement stage having extremely precise structure in e.g., the last ^{˜}5-10% of generation process.

Although not depicted in FIG. 5, plots of content formation intensity values for different runs of the sampling network can differ, but the morphology can be consistently similar between the different runs. The consistent morphology or shape may reveal a very consistent pattern for diffusion models, giving insights as to when structure is generally formed in a diffusion process.

Knowing the stages, and content formation intensities at different denoising operations at different indices, can help designers make more informed design choices for a diffusion model. For example, designers may use the information to decide whether to increase the number of denoising operations to perform. Designers may use the information to determine a variance schedule. Designers may use the information to increase or decrease compute operations dedicated to, and/or computational complexity of, a denoising operation in the sampling network given the index of the denoising operation. Designers may use the information to tune one or more hyperparameters of the deep learning models in the sampling network. Designers may use the information to modify the loss function used for training the sampling network.

### An Exemplary Method for Making Diffusion Models Explainable

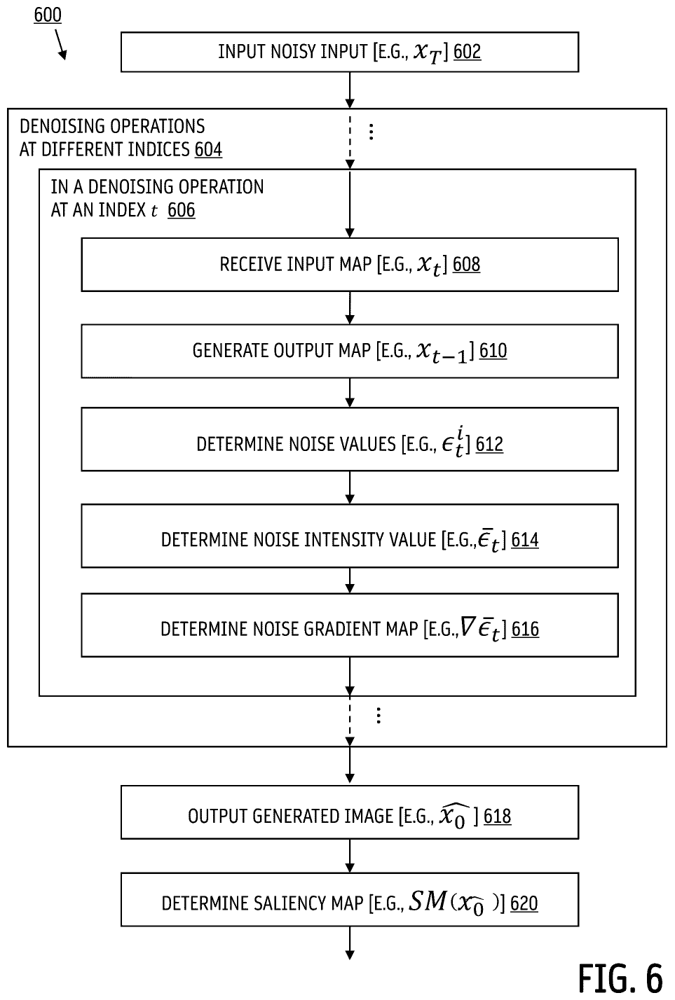

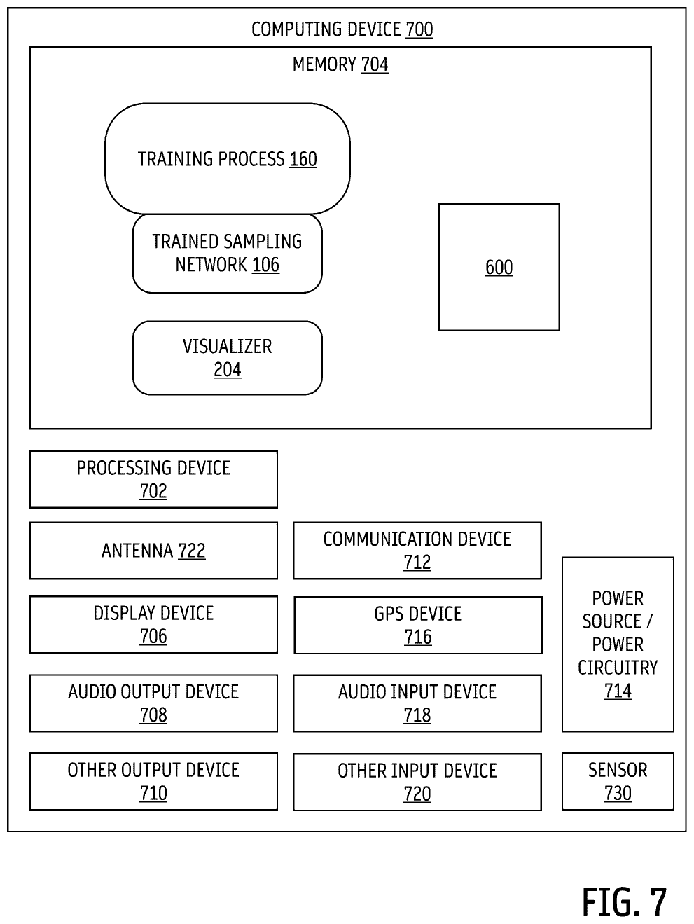

FIG. 6 is a flowchart showing a method 600 that can help make diffusion models more explainable, according to some embodiments of the disclosure. Method 600 can be performed using a computing device, such as computing device 700 in FIG. 7. Method 600 may be performed using one or more parts illustrated FIGS. 1-3. Method 600 may be an exemplary method performed by a sampling network and a visualizer, as illustrated in FIGS. 2-3.

In 602, a noisy input, e.g., x_{T}, may be input into a sampling network. An example of the sampling network is sampling network 106 of the FIGS. The sampling network may include a number of denoising operations at different indices.

In 604, the denoising operations at different indices are depicted.

In 606, a denoising operation at an index t is depicted.

In 608, an input map, e.g., xₜ, may be received at the denoising operation at index t.

In 610, an output map, e.g., xₜ₋₁, may be generated using one or more learned parameters of the denoising operation. The output map may represent a denoised version of the input map.

In 612, noise values, e.g., ϵₜⁱ, corresponding to pixels of the input map may be determined.

In 614, a noise intensity value, e.g., ϵ̅ₜ, may be determined using the noise values.

In 616, a noise gradient map, e.g., ∇ϵ̅ₜ, may be determined using the noise intensity value.

In 618, a generated image, e.g., [symbol] , may be output at an output of a last denoising operation of the sampling network.

In 620, a saliency map, e.g., SM( [symbol] ), may be determined using the noise gradient maps corresponding to the denoising operations at the different indices.

Although the operations of the example method shown in and described with reference to FIG. 6 are illustrated as occurring once each and in a particular order, it will be recognized that the operations may be performed in any suitable order and repeated as desired. Additionally, one or more operations may be performed in parallel. Furthermore, the operations illustrated in FIG. 6 may be combined or may include more or fewer details than described.

### Exemplary Computing Device

FIG. 7 is a block diagram of an apparatus or a system, e.g., an exemplary computing device 700, according to some embodiments of the disclosure. One or more computing devices 700 may be used to implement the functionalities described with the FIGS. and herein. A number of components are illustrated in the FIGS. can be included in the computing device 700, but any one or more of these components may be omitted or duplicated, as suitable for the application. In some embodiments, some or all of the components included in the computing device 700 may be attached to one or more motherboards. In some embodiments, some or all of these components are fabricated onto a single system on a chip (SoC) die. Additionally, in various embodiments, the computing device 700 may not include one or more of the components illustrated in FIG. 7, and the computing device 700 may include interface circuitry for coupling to the one or more components. For example, the computing device 700 may not include a display device 706, and may include display device interface circuitry (e.g., a connector and driver circuitry) to which a display device 706 may be coupled. In another set of examples, the computing device 700 may not include an audio input device 718 or an audio output device 708 and may include audio input or output device interface circuitry (e.g., connectors and supporting circuitry) to which an audio input device 718 or audio output device 708 may be coupled.

The computing device 700 may include a processing device 702 (e.g., one or more processing devices, one or more of the same types of processing device, one or more of different types of processing device). The processing device 702 may include electronic circuitry that process electronic data from data storage elements (e.g., registers, memory, resistors, capacitors, quantum bit cells) to transform that electronic data into other electronic data that may be stored in registers and/or memory. Examples of processing device 702 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 700 may include a memory 704, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 704 includes one or more non-transitory computer-readable storage media. In some embodiments, memory 704 may include memory that shares a die with the processing device 702. In some embodiments, memory 704 includes one or more non-transitory computer-readable media storing instructions executable to perform operations described with the FIGS. and herein, such as the methods illustrated in FIGS. 12-15. Exemplary parts that may be encoded as instructions and stored in memory 704 are depicted. Memory 704 may store instructions that encode one or more exemplary parts. The instructions stored in the one or more non-transitory computer-readable media may be executed by processing device 702. In some embodiments, memory 704 may store data, e.g., data structures, binary data, bits, metadata, files, blobs, etc., as described with the FIGS. and herein. Exemplary data that may be stored in memory 704 are depicted. Memory 704 may store one or more data as depicted.

In some embodiments, memory 704 may store one or more machine learning models (and or parts thereof). Memory 704 may store training data for training (trained) sampling network 106. Memory 704 may store instructions that perform operations associated with training process 160 of FIG. 1. Memory 704 may store input data, output data, intermediate outputs, intermediate inputs of one or more machine learning models. Memory 704 may store instructions to perform one or more operations of the machine learning model. Memory 704 may store one or more parameters used by the machine learning model. Memory 704 may store information that encodes how processing units of the machine learning model are connected with each other. Examples of machine learning models or parts of a machine learning model may include (trained) sampling network 106 of the FIGS. Memory 704 may store instructions that perform operations associated with visualizer 204 of the FIGS.

In some embodiments, the computing device 700 may include a communication device 712 (e.g., one or more communication devices). For example, the communication device 712 may be configured for managing wired and/or wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 712 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 712 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 712 may operate in accordance with other wireless protocols in other embodiments. The computing device 700 may include an antenna 722 to facilitate wireless communications and/or to receive other wireless communications (such as radio frequency transmissions). The computing device 700 may include receiver circuits and/or transmitter circuits. In some embodiments, the communication device 712 may manage wired communications, such as electrical, optical, or any other suitable communication protocols (e.g., the Ethernet). As noted above, the communication device 712 may include multiple communication chips. For instance, a first communication device 712 may be dedicated to shorter-range wireless communications such as Wi-Fi or Bluetooth, and a second communication device 712 may be dedicated to longer-range wireless communications such as global positioning system (GPS), EDGE, GPRS, CDMA, WiMAX, LTE, EV-DO, or others. In some embodiments, a first communication device 712 may be dedicated to wireless communications, and a second communication device 712 may be dedicated to wired communications.

The computing device 700 may include power source/power circuitry 714. The power source/power circuitry 714 may include one or more energy storage devices (e.g., batteries or capacitors) and/or circuitry for coupling components of the computing device 700 to an energy source separate from the computing device 700 (e.g., DC power, AC power, etc.).

The computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

The computing device 700 may include an audio output device 708 (or corresponding interface circuitry, as discussed above). The audio output device 708 may include any device that generates an audible indicator, such as speakers, headsets, or earbuds, for example.

The computing device 700 may include an audio input device 718 (or corresponding interface circuitry, as discussed above). The audio input device 718 may include any device that generates a signal representative of a sound, such as microphones, microphone arrays, or digital instruments (e.g., instruments having a musical instrument digital interface (MIDI) output).

The computing device 700 may include a GPS device 716 (or corresponding interface circuitry, as discussed above). The GPS device 716 may be in communication with a satellite-based system and may receive a location of the computing device 700, as known in the art.

The computing device 700 may include a sensor 730 (or one or more sensors). The computing device 700 may include corresponding interface circuitry, as discussed above). Sensor 730 may sense physical phenomenon and translate the physical phenomenon into electrical signals that can be processed by, e.g., processing device 702. Examples of sensor 730 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 700 may include another output device 710 (or corresponding interface circuitry, as discussed above). Examples of the other output device 710 may include an audio codec, a video codec, a printer, a wired or wireless transmitter for providing information to other devices, haptic output device, gas output device, vibrational output device, lighting output device, home automation controller, or an additional storage device.

The computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 700 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 700 may be any other electronic device that processes data.

### Exemplary Machine Learning Models and Parts Thereof

The sampling network and denoising operations described herein may be implemented using one or more machine learning models, e.g., using one or more deep learning models.

A machine learning model refers to computer-implemented systems that can perform one or more tasks. A machine learning model can take an input and generate an output for the task at hand. Using and implementing a machine learning model may involve supervised learning, unsupervised learning, semi-supervised learning, and reinforcement learning. A machine learning model can be implemented in different ways. A machine learning model can include one or more of: an artificial neural network, a deep learning model, a decision tree, a support vector machine, regression analysis, a Bayesian network, a Gaussian process, a genetic algorithm, etc.

An artificial neural network may include one or more layers, modules, networks, blocks and/or operator that transform the input into an output. In some embodiments, a layer, module, network, block and/or operator may include one or more processing units and/or one or more processing nodes. A processing unit may receive one or more inputs, perform a processing function or operation, and generate one or more outputs. Processing units may be interconnected to form a network. In some cases, the processing units or nodes may be referred to as neurons. Different types of processing units or nodes may be distinguished by the processing function/operation that is being performed by the processing units or nodes. A processing unit may include one or more parameters. The parameters may be trained or learned. A processing unit may include one or more hyperparameters. Hyperparameters may be set or tuned, adjusted, or set by one or more users of the machine learning model.

One type of processing unit is a convolution block and/or operator. The processing unit applies a convolution operation to the input and generates an output. The convolution operation may extract features from the input and output the features as the output. The convolution operation may transform the input and generate an output. The processing unit may convolve the input with a kernel to generate an output. A kernel may include a matrix. The kernel may encode a function or operation that can transform the input. The kernel may include values or parameters that can be trained or learned. The processing unit may compute inner products (e.g., dot products) with a sliding/moving window capturing local regions or patches of the input and sum and/or accumulate the inner products to generate an output. Inner products may be computed successively across the input matrix, as the sliding/moving windows move across the input matrix. A convolution block and/or operator may be defined by the size of the kernel, e.g., a 1×1 convolution (a convolutional operator having a kernel size of 1×1), a 2×2 convolution(a convolutional operator having a kernel size of 2×2), a 3×3 convolution (a convolutional operator having a kernel size of 3×3), a 4×4 convolution (a convolutional operator having a kernel size of 4×4), a 5×5 convolution (a convolutional operator having a kernel size of 5×5), and so forth. The distance the window slides/moves can be set or defined by the stride of the convolution operator. In some cases, the convolution block and/or operator may apply no padding and uses the input matrix as-is. In some cases, the convolution block and/or operator may apply half padding and pads around a part of the input matrix. In some cases, the convolution block and/or operator may apply full padding and pads around the input matrix. In some cases, the convolution block and/or operator may be defined by a dimension of the filter being applied. For example, a 1-D convolution block and/or operator may apply a sliding convolution filter or kernel of size k (a hyperparameter) to one-dimensional input. Values in the sliding convolution filter or kernel can be trained and/or learned.

An exemplary layer, module, block and/or operator may include a dilation convolution block may increase can extract features at various scales. A dilation convolution block may expand the kernel by inserting gaps between the weights in the kernel. A dilation convolution module may have a dilation rate or dilation factor which indicates how much the kernel is widened. Parameters in the kernel can be trained or learned.

Another type of processing unit is a transformer unit or block. A transformer unit may be used in a transformer block. A transformer unit may implement an attention mechanism to extract dependencies between different parts of the input to the transformer unit. A transformer unit may receive an input and generate an output that represents the significance or attention of various parts of the input. A transformer unit may include query weights, key weights, and value weights as parameters that can be trained or learned. A transformer unit may apply the parameters to extract relational information between different parts of the input to the transformer unit.

Another type of processing unit is an activation unit or block. An activation block may implement or apply an activation function (e.g., a sigmoid function, a non-linear function, hyperbolic tangent function, rectified linear unit, leaky rectified linear unit, parametric rectified linear unit, sigmoid linear unit, exponential linear unit, scaled exponential linear function, logistic activation function, Heaviside activation function, identity function, binary step function, soft step function, Gaussian error linear unit, Gaussian function, softplus function, etc.) to an input to the activation block and generate an output. An activation block can be used to map an input to the block to a value between 0 and 1. An activation block can be used to map an input to the block to a zero (0) or a one (1). An activation block can introduce non-linearity. An activation block can learn complex decision boundaries. One or more parameters of the activation function can be trained or learned.

An exemplary layer, module, block, or operator may include an upsampling block. An upsampling block may increase the size of the input features or feature maps. An upsampling block may synthesize values that can be added to the input features or feature maps to increase the size and output features or feature maps that are upsampled.

An exemplary layer, module, block, or operator may include a downsampling block. A downsampling block may perform downsampling of features or feature maps generated by the stages, which may improve running efficiency of machine learning model. A downsampling block may include a pooling layer, which may receive feature maps at its input and applies a pooling operation to the feature maps. The output of the pooling layer can be provided or inputted into a subsequent stage for further processing. The pooling operation can reduce the size of the feature maps while preserving their (important) characteristics. Accordingly, the pooling operation may improve the efficiency of the overall model and can avoid over-learning. A pooling layer may perform the pooling operation through average pooling (calculating the average value for each patch on the feature map), max pooling (calculating the maximum value for each patch of the feature map), or a combination of both. The size of an output of a pooling layer is smaller than the size of the feature maps provided as input to the pooling layer. In some embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In some embodiments, a pooling layer applied to a feature map of 6×6 results in an output pooled feature map of 3×3.

An exemplary layer, module, block, or operator may include a projection layer (sometimes referred to as a 1×1 convolution block and/or operator). A projection layer may transform input features into a new space, such as a space that is suitable, informative, and/or useful for tasks being performed by modules downstream (for processing by modules downstream). A projection layer may include a dense layer, or a fully connected layer where each neuron (e.g., a node or processing unit in a neural network) is connected to every neuron of the previous layer. A projection layer may generate and/or output one or more new features (e.g., a new set of features) that are more abstract or high-level than features in the input. A projection layer may implement one or more 1×1 convolution operations, where the projection layer may convolve the input features with filters of size 1×1 (e.g., with zero-padding and a stride of 1). A projection layer may implement channel-wise pooling or feature map pooling. A projection layer may reduce dimensionality of the input features by pooling features across channels. A projection layer may implement a 1×1 filter to create a linear projection of a stack of feature maps. A projection layer may implement a 1×1 filter to increase the number of feature maps. A projection layer may implement a 1×1 filter to decrease the number of channels. A projection layer may make the feature maps compatible with subsequent processing layers, modules, blocks, or operators. A projection layer may ensure that an element-wise adding operation can be performed to add the output of the projection layer and another feature map. A projection layer can ensure the dimensionality of the output of the projection layer matches the dimensionality of the feature map being element-wise added together. Parameters of the projection layer can be trained or learned.

An exemplary block may include an adder block. An adder block may perform element-wise adding of two or more inputs to generate an output. An adder block can be an exemplary block that can merge and/or combine two or more inputs together. Adding and summing may be synonymous. An adder block may be replaced by a concatenate block.

An exemplary block may include a multiplier block. A multiplier block may perform element-wise multiplication of two or more inputs to generate an output. A multiplier block may determine a Hadamard product.

An exemplary block may include a concatenate block. A concatenate block may perform concatenation of two or more inputs to generate an output. A concatenate block may append vectors and/or matrices in the inputs to form a new vector and/or matrix. Vector concatenation can be appended to form a larger vector. Matrix concatenation can be performed horizontally, vertically, or in a merged fashion. Horizontal matrix concatenation can be performed by concatenating matrices (that have the same height) in the inputs width-wise. Vertical matrix concatenation can be performed by concatenating matrices (that have the same width) in the inputs height-wise. A concatenate block can be an exemplary block that can merge and/or combine two or more inputs together. A concatenate block may be suitable when the two or more inputs do not have the same dimensions. A concatenate block may be suitable when it is desirable to keep the two or more inputs unchanged or intact (e.g., to not lose information). A concatenate block may be replaced by an adder block.

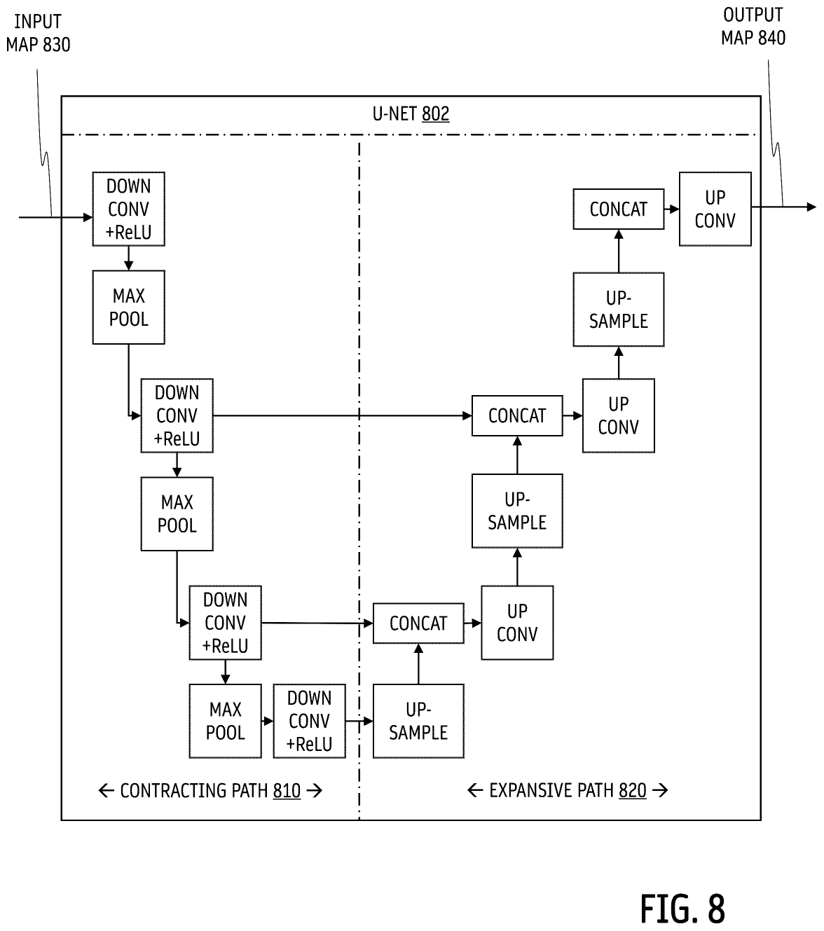

FIG. 8 is a block diagram of an exemplary deep learning model, e.g., U-Net 802, according to some embodiments of the disclosure. As discussed herein, a denoising operation may include one or more deep learning models. A denoising operation may include a U-Net, such as the U-Net 802 depicted in FIG. 8. The operations depicted in FIG. 8 for U-Net 802 are meant to be illustrative, and a U-Net may be implemented in other ways.

U-Net 802 may be a type of convolutional neural network comprising a plurality of layers/successive operations. U-Net 802 may receive an input map 830 and output an output map 840. U-Net 802 may have a U-shaped architecture that comprises a contracting path 810 and an expansive path 820. The expansive path 820 may be symmetric to the contracting path 810. The contracting path 810 can capture the context of the input map, while the expansive path 820 can reconstruct the output map with precise localization.

The contracting path 810 may include a convolutional neural network comprising repeated applications of down convolutions, where each application of down convolution (“DOWN CONV”) may be followed by a rectified linear unit (“ReLU”) and a max pooling (“MAX POOL”) operation. Application of down convolution followed by the rectified linear unit is depicted as “DOWN CONV+ReLU”. The max pooling operation is depicted as “MAX POOL”. The contracting path 810 may reduce spatial information (thus compressing or contracting the input), while increasing feature information. The contracting path 810 may include encoder layers that capture contextual information and reduce the spatial resolution of the input. The contracting path 810 may identify relevant features in the input map 830 and perform convolution operations that can reduce the spatial resolution of the feature maps while increasing their depth. The contracting path 810 may capture increasingly abstract representations of the input.

The expansive path 820 may combine feature and spatial information through a sequence of upsampling operations (“UP-SAMPLE”), concatenations (“CONCAT”) operations with features from the contracting path 810, and up convolutions (“UPCONV”). The upsampling operation is depicted as “UP-SAMPLE”. The concatenation operation is depicted as “CONCAT”. The up convolution operation is depicted as “UP CONV”. The expansive path 820 may increase spatial dimensions (thus expansive or decompressing) and decrease the feature information of the input. The expansive path 820 may include decoder layers that decode the encoded data and use the information from the contracting path 810 via skip connections (e.g., the concatenate operations) to generate the output. The expansive path 820 may decode the encoded data and locating the features while maintaining the spatial resolution of the input. The expansive path 820 may up-sample the feature maps, while also performing convolutional operations. The skip connections from contracting path 810 help to preserve the spatial information lost in the contracting path, which can help the expansive path 820 to decode and locate the features more accurately.

U-Net 802 can be trained end-to-end using a pixel-wise cross entropy loss function, which can measure the difference between the predicted output map and the ground truth output map. When used as a denoising operation, U-Net 802 may be trained to match a ground truth denoised version of the input map, which can be obtained from the forward diffusion process 102 and/or a backward diffusion process 104 illustrated in FIG. 1.

### SELECT EXAMPLES

Example 1 provides a method, including inputting a noisy input into a sampling network including denoising operations at different indices; in a denoising operation at an index: receiving an input map; generating an output map using one or more learned parameters of the denoising operation, the output map representing a denoised version of the input map; determining noise values corresponding to pixels of the input map; determining a noise intensity value using the noise values; and determining a noise gradient map using the noise intensity value; outputting a generated image at an output of a last denoising operation of the sampling network; and determining a saliency map using the noise gradient maps corresponding to the denoising operations at the different indices.

Example 2 provides the method of example 1, where determining the noise values includes determining pixel-wise differences of the input map and the output map.

Example 3 provides the method of example 1 or 2, where determining the noise intensity value includes determining a mean of the noise values.

Example 4 provides the method of any one of examples 1-3, where determining the noise gradient map includes determining pixel-wise partial derivatives of the noise intensity value with respect to a pixel of the input map.

Example 5 provides the method of example 4, where determining the noise gradient map includes normalizing the pixel-wise partial derivatives based on a magnitude of the pixel-wise partial derivatives.

Example 6 provides the method of any one of examples 1-5, where determining the saliency map includes combining the noise gradient maps of the denoising operations at the different indices.

Example 7 provides the method of any one of examples 1-6, where determining the saliency map includes accumulating the noise gradient maps using weights corresponding to the denoising operations at the different indices, where a weight includes a depth of a particular denoising operation at a particular index in the sampling network divided by a total number of denoising operations in the sampling network.

Example 8 provides the method of any one of examples 1-7, further including in the denoising operation at the index, determining a concept formation intensity value based on a magnitude of pixel-wise partial derivatives of the noise intensity value with respect to a pixel of the input map.

Example 9 provides an apparatus, including one or more processors for executing instructions; and a non-transitory computer-readable memory storing the instructions, the instructions causing the one or more processors to: input a noisy input into a sampling network including denoising operations at different indices; for a denoising operation at an index: receive an input map; generate an output map using one or more learned parameters of the denoising operation, the output map representing a denoised version of the input map; determine noise values corresponding to pixels of the input map, the noise values including pixel-wise differences of the input map and the output map; determine a noise intensity value using the noise values; and determine a noise gradient map using the noise intensity value; output a generated image at an output of a last denoising operation of the sampling network; and determine a saliency map using the noise gradient maps corresponding to the denoising operations at the different indices.

Example 10 provides the apparatus of example 9, where determining the noise intensity value includes determining an average of the noise values.

Example 11 provides the apparatus of example 9 or 10, where determining the noise gradient map includes determining pixel-wise partial derivatives of the noise intensity value with respect to a pixel of the input map.

Example 12 provides the apparatus of example 11, where determining the noise gradient map includes normalizing the pixel-wise partial derivatives based on a magnitude of the pixel-wise partial derivatives.

Example 13 provides the apparatus of any one of examples 9-12, where determining the saliency map includes combining the noise gradient maps of the denoising operations at the different indices.

Example 14 provides the apparatus of any one of examples 9-13, where determining the saliency map includes accumulating the noise gradient maps using weights corresponding to the denoising operations at the different indices, where a weight includes a depth of a particular denoising operation at a particular index in the sampling network divided by a total number of denoising operations in the sampling network.

Example 15 provides the apparatus of any one of examples 9-14, where the operations further includes for the denoising operation at the index, determine a concept formation intensity value based on a magnitude of pixel-wise partial derivatives of the noise intensity value with respect to a pixel of the input map.

Example 16 provides one or more non-transitory computer-readable media storing instructions that, when executed by one or more processors, cause the one or more processors to: input a noisy input into a sampling network including denoising operations at different indices; in a denoising operation at an index: receive an input map; generate an output map using one or more learned parameters of the denoising operation, the output map representing a denoised version of the input map; determine noise values corresponding to pixels of the input map; determine a noise intensity value using the noise values; and determine a noise gradient map using the noise intensity value; output a generated image at an output of a last denoising operation of the sampling network; and determine a saliency map using the noise gradient maps corresponding to the denoising operations at the different indices.

Example 17 provides the one or more non-transitory computer-readable media of example 16, where determining the noise values includes determining pixel-wise differences of the input map and the output map.

Example 18 provides the one or more non-transitory computer-readable media of example 16 or 17, where determining the noise intensity value includes determining a median of the noise values.

Example 19 provides the one or more non-transitory computer-readable media of any one of examples 16-18, where determining the noise gradient map includes determining pixel-wise partial derivatives of the noise intensity value with respect to a pixel of the input map; and normalizing the pixel-wise partial derivatives based on a magnitude of the pixel-wise partial derivatives.

Example 20 provides the one or more non-transitory computer-readable media of any one of examples 16-19, where determining the saliency map includes accumulating the noise gradient maps using weights corresponding to the denoising operations at the different indices, where a weight is higher when a depth of a particular denoising operation at a particular index in the sampling network is higher.

Example 21 provides one or more non-transitory computer-readable media storing instructions that, when executed by one or more processors, cause the one or more processors to perform any one of the methods provided in Examples 1-8.

Example 55 provides an apparatus comprising means to carry out or means for carrying out any one of the methods provided in Examples 1-8.

### Variations and Other Notes

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
inputting a noisy input into a sampling network comprising denoising operations at different indices;
in a denoising operation at an index:
receiving an input map;
generating an output map using one or more learned parameters of the denoising operation, the output map representing a denoised version of the input map;
determining noise values corresponding to pixels of the input map;
determining a noise intensity value using the noise values; and
determining a noise gradient map using the noise intensity value;
outputting a generated image at an output of a last denoising operation of the sampling network; and
determining a saliency map using the noise gradient maps corresponding to the denoising operations at the different indices.

2. The method of claim 1, wherein determining the noise values comprises:
determining pixel-wise differences of the input map and the output map.

3. The method of claim 1, wherein determining the noise intensity value comprises:
determining a mean of the noise values.

4. The method of claim 1, wherein determining the noise gradient map comprises:
determining pixel-wise partial derivatives of the noise intensity value with respect to a pixel of the input map.

5. The method of claim 4, wherein determining the noise gradient map comprises:
normalizing the pixel-wise partial derivatives based on a magnitude of the pixel-wise partial derivatives.

6. The method of claim 1, wherein determining the saliency map comprises:
combining the noise gradient maps of the denoising operations at the different indices.

7. The method of claim 1, wherein determining the saliency map comprises:
accumulating the noise gradient maps using weights corresponding to the denoising operations at the different indices, wherein a weight comprises a depth of a particular denoising operation at a particular index in the sampling network divided by a total number of denoising operations in the sampling network.

8. The method of claim 1, further comprising:
in the denoising operation at the index, determining a concept formation intensity value based on a magnitude of pixel-wise partial derivatives of the noise intensity value with respect to a pixel of the input map.

9. An apparatus, comprising:
one or more processors for executing instructions; and
a non-transitory computer-readable memory storing the instructions, the instructions causing the one or more processors to:
input a noisy input into a sampling network comprising denoising operations at different indices;
for a denoising operation at an index:
receive an input map;
generate an output map using one or more learned parameters of the denoising operation, the output map representing a denoised version of the input map;
determine noise values corresponding to pixels of the input map, the noise values comprising pixel-wise differences of the input map and the output map;
determine a noise intensity value using the noise values; and
determine a noise gradient map using the noise intensity value;
output a generated image at an output of a last denoising operation of the sampling network; and
determine a saliency map using the noise gradient maps corresponding to the denoising operations at the different indices.

10. The apparatus of claim 9, wherein determining the noise intensity value comprises:
determining an average of the noise values.

11. The apparatus of claim 9, wherein determining the noise gradient map comprises:
determining pixel-wise partial derivatives of the noise intensity value with respect to a pixel of the input map.

12. The apparatus of claim 11, wherein determining the noise gradient map comprises:
normalizing the pixel-wise partial derivatives based on a magnitude of the pixel-wise partial derivatives.

13. The apparatus of claim 9, wherein determining the saliency map comprises:
combining the noise gradient maps of the denoising operations at the different indices.

14. The apparatus of claim 9, wherein determining the saliency map comprises:
accumulating the noise gradient maps using weights corresponding to the denoising operations at the different indices, wherein a weight comprises a depth of a particular denoising operation at a particular index in the sampling network divided by a total number of denoising operations in the sampling network.

15. The apparatus of claim 9, wherein the operations further comprises:
for the denoising operation at the index, determine a concept formation intensity value based on a magnitude of pixel-wise partial derivatives of the noise intensity value with respect to a pixel of the input map.

16. One or more non-transitory computer-readable media storing instructions that, when executed by one or more processors, cause the one or more processors to:
input a noisy input into a sampling network comprising denoising operations at different indices;
in a denoising operation at an index:
receive an input map;
generate an output map using one or more learned parameters of the denoising operation, the output map representing a denoised version of the input map;
determine noise values corresponding to pixels of the input map;
determine a noise intensity value using the noise values; and
determine a noise gradient map using the noise intensity value;
output a generated image at an output of a last denoising operation of the sampling network; and
determine a saliency map using the noise gradient maps corresponding to the denoising operations at the different indices.

17. The one or more non-transitory computer-readable media of claim 16, wherein determining the noise values comprises:
determining pixel-wise differences of the input map and the output map.

18. The one or more non-transitory computer-readable media of claim 16, wherein determining the noise intensity value comprises:
determining a median of the noise values.

19. The one or more non-transitory computer-readable media of claim 16, wherein determining the noise gradient map comprises:
determining pixel-wise partial derivatives of the noise intensity value with respect to a pixel of the input map; and
normalizing the pixel-wise partial derivatives based on a magnitude of the pixel-wise partial derivatives.

20. The one or more non-transitory computer-readable media of claim 16, wherein determining the saliency map comprises:
accumulating the noise gradient maps using weights corresponding to the denoising operations at the different indices, wherein a weight is higher when a depth of a particular denoising operation at a particular index in the sampling network is higher.
